(19) United States
(12) Patent Application Publication
(10) Pub. No.: US 2026/0239517 A1
(43) Pub. Date: Aug. 13, 2026

(54) DIRECTION AND REQUEST-BASED VEHICLE ILLUMINATION

(71) Applicant: Toyota Jidosha Kabushiki Kaisha, Toyota-shi Aichi-ken (JP)

(72) Inventors: Alexander Charles Granieri, Mountain View, CA (US); Jimmy Chiu, San Jose, CA (US); Brian R. Hilnbrand, San Jose, CA (US); Roger Louie, San Francisco, CA (US); Carlos Aldama, Salinas, CA (US); Armon Jonathan Amirriazi, Sunnyvale, CA (US); Tristan Robert Littlehale, San Jose, CA (US); Navid Fattahi, San Jose, CA (US)

(73) Assignee: Toyota Jidosha Kabushiki Kaisha, Toyota-shi Aichi-ken (JP)

(21) Appl. No.: 19/049,087

(22) Filed: Feb. 10, 2025

(51) Int. Cl. H05B 47/175; B60Q 3/14; B60Q 3/16

(52) U.S. Cl. CPC H05B 47/197; B60Q 3/14; B60Q 3/16; H05B 47/1975

(57) ABSTRACT

Systems, methods, and other embodiments described herein relate to providing visual feedback to a user that a user request for information or action was received by a vehicle system. In one embodiment, a method includes identifying, from data captured by a sensor of a vehicle, a direction specified in a user request. The method also includes mapping the direction specified in the user request to a corresponding location along an illumination strip encompassing a portion of the vehicle. The method also includes activating an illumination element of the illumination strip. The illumination element is at the corresponding location along the illumination strip that maps to the direction specified in the user request.

### TECHNICAL FIELD

The subject matter described herein relates, in general, to human vehicle interactions and, more particularly, to providing visual feedback regarding the receipt of a direction-based user request of a vehicle system.

### BACKGROUND

Vehicles are becoming increasingly advanced. Modern vehicles include a greater quantity of and more complex systems than would have been imagined ten years ago. These advancements enhance the vehicle's operational capabilities and may also enhance the occupant experience.

One example of a technological development that has increased the occupant experience is the inclusion of advanced interface elements within a vehicle. In general, an interface element is a component through which an occupant may interact with vehicle systems. Historically, occupants have interacted with their vehicle components (e.g., air conditioning, radio, etc.) via manual hand-operated controls such as knobs, switches, buttons, etc. Some vehicles may include a human-machine interface (HMI). An HMI is an interface through which an occupant may interact with these same vehicle systems (e.g., air conditioning and radio systems) and other recently incorporated systems, such as navigation and communication systems, among others. HMIs may include touchscreens through which an occupant can control or interact with various vehicle systems. Some HMI systems may even respond to voice commands. In such an example, a vehicle occupant may be able to control a vehicle system without taking their eyes off the road, for example, to look at an HMI screen.

In general, advancements in the human vehicle interaction system may enhance the occupant experience within a vehicle, ensuring reliable, safe, and satisfactory experiences within the vehicle.

### SUMMARY

In one embodiment, example systems and methods relate to a manner of improving a human vehicle interaction environment.

In one embodiment, a request feedback system for acknowledging receipt of a direction specified in a user request is disclosed. The request feedback system includes one or more processors and a memory communicably coupled to the one or more processors. The memory stores instructions that, when executed by the one or more processors, cause the one or more processors to identify, from data captured by a sensor of a vehicle, a direction specified in a user request. The memory also stores instructions that, when executed by the one or more processors, cause the one or more processors to map the direction specified in the user request to a corresponding location along an illumination strip encompassing a portion of the vehicle. The memory also stores instructions that, when executed by the one or more processors, cause the one or more processors to activate an illumination element of the illumination strip. The illumination element is at the corresponding location along the illumination strip that maps to the direction specified in the user request.

In one embodiment, the request feedback system includes an illumination strip attached to and encompassing a portion of a vehicle. The request feedback system also includes one or more processors and a memory communicably coupled to the one or more processors. The memory stores instructions that, when executed by the one or more processors, cause the one or more processors to identify, from data captured by a sensor of a vehicle, a direction specified in a user request. The memory also stores instructions that, when executed by the one or more processors, cause the one or more processors to map the direction specified in the user request to a corresponding location along the illumination strip. The memory also stores instructions that, when executed by the one or more processors, cause the one or more processors to activate an illumination element of the illumination strip. The illumination element is at the corresponding location along the illumination strip that maps to the direction specified in the user request.

In one embodiment, a method for acknowledging receipt of a direction specified in a user request is disclosed. In one embodiment, the method includes identifying, from data captured by a sensor of a vehicle, a direction specified in a user request. The method also includes mapping the direction specified in the user request to a corresponding location along an illumination strip encompassing a portion of the vehicle. The method also includes activating an illumination element of the illumination strip. The illumination element is at the corresponding location along the illumination strip that maps to the direction specified in the user request.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates an embodiment of a vehicle within which systems and methods disclosed herein may be implemented.

FIG. 2 illustrates an embodiment of a request feedback system that is associated with acknowledging the receipt of a direction specified in a user request.

FIG. 3 depicts an environment-facing view of a request feedback system acknowledging the receipt of a direction specified in a user request.

FIG. 4 depicts a driver-facing view of a request feedback system acknowledging the receipt of a direction specified in a user request.

FIG. 5 depicts a schematic of a request feedback system acknowledging the receipt of a direction specified in a user request.

FIG. 6 illustrates a flowchart for one embodiment of a method that is associated with acknowledging the receipt of a direction specified in a user request.

FIG. 7 depicts a view of a request feedback system acknowledging the receipt of a direction specified in a user request from a source external to the vehicle.

FIG. 8 illustrates a flowchart for one embodiment of a method that is associated with acknowledging the receipt of a direction specified in a user request.

### DETAILED DESCRIPTION

Systems, methods, and other embodiments associated with improving human interactions in vehicles are disclosed herein. As previously described, vehicles are becoming more advanced with greater operational capability and other features that enhance the user experience. For example, some vehicles include advanced human-machine interfaces (HMIs) to simplify and enhance the occupant's ability to control or interact with the vehicle. Such HMIs may include touch screens through which a vehicle occupant may issue commands to various vehicle systems. However, such HMIs may be limited in their capabilities. For example, a touch-based HMI may be unable to process hand gestures as a control modality and may require a driver to remove their eyes from the road and their hands from the steering wheel to control the vehicle, which may be dangerous. As another example, some vehicle systems may provide generic indicators about the presence of objects, such as pedestrians or other vehicles. These systems are static systems that do not facilitate bi-directional interaction between the vehicle and the occupant.

Accordingly, the present specification describes a system that recognizes additional user input forms and provides a visual feedback mechanism to acknowledge that the input was received and correctly processed. Specifically, during operation, a user may request information or an action. For example, an occupant may desire additional information regarding an establishment or object in the immediate surroundings. The system of the present specification may identify the direction of an object of the query (i.e., an object about which the user desires additional information) and may provide visual confirmation that the query and the direction of the object of the query were received and processed. For example, while pointing in a particular direction, a user may say, “What is that store?”. In this scenario, the user may desire to know whether the vehicle system provides a response that corresponds to the query, for example, by providing information about the store that the user is pointing at rather than a different store.

As another example, an occupant may desire to instigate an action of a vehicle system. The system of the present specification may identify the direction of the requested action (i.e., a component of the vehicle 100 that the user desires to control) and provide visual confirmation that the user request and the location of the object of the user request were received and processed. For example, while pointing behind them, a driver may verbally provide a command of “open the rear trunk.” In this scenario, the driver may desire to know whether the vehicle system correctly identified the action to be executed.

In either example, incorrectly identifying the object of the query/command may lead to confusion and a less-than-satisfactory user experience. Accordingly, the system of the present specification provides a visual feedback mechanism so that the occupant can have confidence in the system's accurate recognition and processing of their request.

Specifically, the system includes an illumination strip that spans the field of view of an occupant of the vehicle. For example, the illumination strip may span at least 180 degrees of the passenger cabin, including across the driver-side door, the vehicle dashboard, and the passenger-side door. The illumination strip can be selectively activated in a specific area to correlate with an external area of the surrounding environment. Specifically, the illumination strip can be selectively activated to align with a direction specified in a user request. As described above, the user request may include a request for information (i.e., a query) or a request for action (i.e., a command).

The user request may take many forms, such as a verbal request accompanied by a gesture, whether a hand/arm gesture or a head/eye gesture. For example, a driver may look generally towards their left and ask, “Is my destination that way?”. As another example, the driver may point towards a gas station to their right and inquire, “Is that gas station open?”. In either case, the system may identify the direction specified in the user request (e.g., the user's destination and the gas station, respectively) and illuminate a portion of the illumination strip associated with the specified direction (i.e., to the driver's left with regards to the destination and to the driver's right with regard to the gas station). Accordingly, a user may specify a direction with verbal and/or non-verbal gestures, and the system may illuminate a portion of the illumination strip that corresponds to the specified direction. Accordingly, a user may know that the system is accurately tracking their gesture and is correctly responding to the user request. Without such a system, the user may question or lack confidence in the provided response to the user request.

In this example, the illumination strip operates as a cursor to the user request provided by an occupant of the vehicle or, in some cases, a user outside of the vehicle. In these cases, the interior illumination strip may be visible from the inside and the outside of the vehicle, and/or the vehicle may include an additional illumination strip affixed to the exterior of the vehicle. Doing so may enhance the human vehicle interaction by providing additional forms of interaction/control over the vehicle (i.e., gesture-based and/or voice-based control). The system also enhances vehicle operation safety by facilitating vehicle control while allowing the driver to remain focused on the road. Even further, the present system enhances the user experience by instilling user confidence in vehicle assistance systems by providing visual feedback regarding the vehicle system's accurate reception of input.

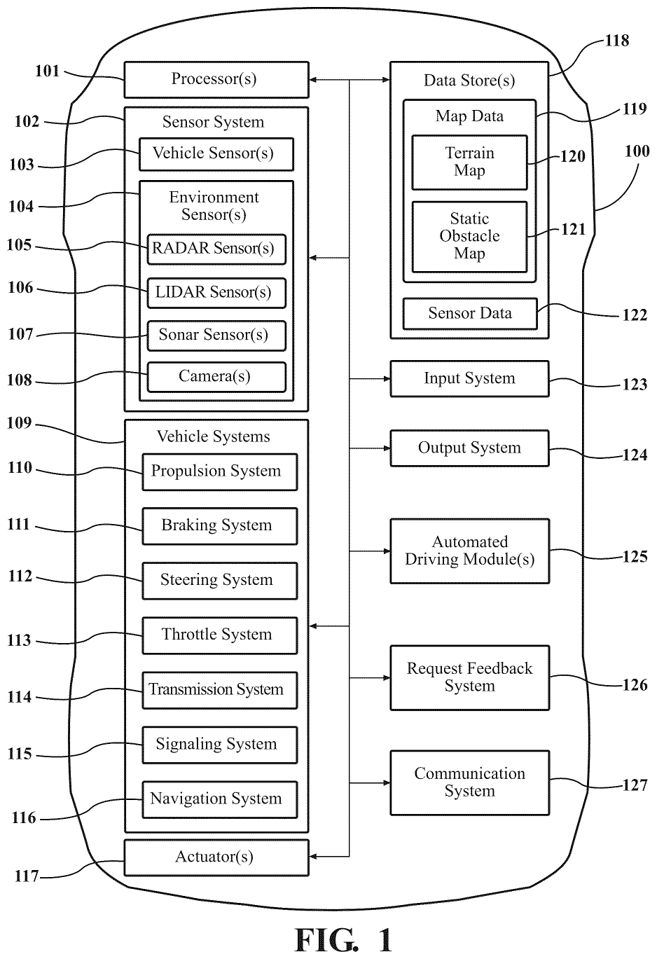

Referring to FIG. 1, an example of a vehicle 100 is illustrated. As used herein, a “vehicle” is any form of transport that may be motorized or otherwise powered. In one or more implementations, the vehicle 100 is an automobile. While arrangements will be described herein with respect to automobiles, it will be understood that embodiments are not limited to automobiles. In some implementations, the vehicle 100 may be a robotic device or a form of transport that, for example, includes sensors to perceive aspects of the surrounding environment, and thus benefits from the functionality discussed herein associated with confirmation of the receipt and accurate processing of gesture-based queries.

The vehicle 100 also includes various elements. It will be understood that in various embodiments it may not be necessary for the vehicle 100 to have all of the elements shown in FIG. 1. The vehicle 100 can have different combinations of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. For example, as discussed, one or more components of the disclosed system can be implemented within a vehicle while further components of the system are implemented within a cloud-computing environment or other system that is remote from the vehicle 100.

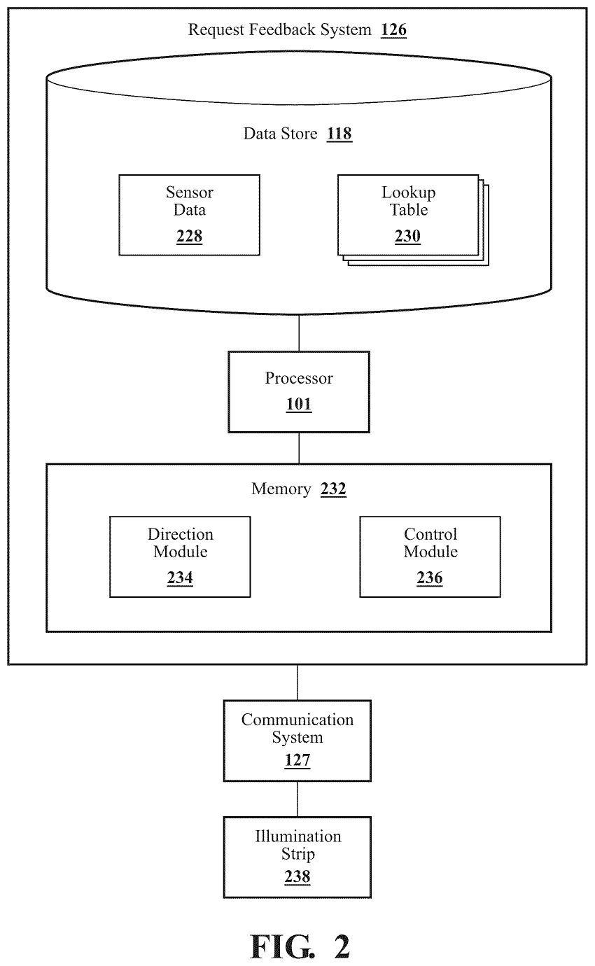

Some of the possible elements of the vehicle 100 are shown in FIG. 1 and will be described along with subsequent figures. However, a description of many of the elements in FIG. 1 will be provided after the discussion of FIGS. 2-8 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the vehicle 100 includes a request feedback system 126 that is implemented to perform methods and other functions as disclosed herein relating to improving human-to-vehicle interaction.

Moreover, the request feedback system 126, as provided for within the vehicle 100, functions in cooperation with a communication system 127. In one embodiment, the communication system 127 communicates according to one or more communication standards. For example, the communication system 127 can include multiple different antennas/transceivers and/or other hardware elements for communicating at different frequencies and according to respective protocols. The communication system 127, in one arrangement, communicates via a communication protocol, such as a WiFi, dedicated short-range communication (DSRC), vehicle-to-infrastructure (V2I), vehicle-to-vehicle (V2V), or another suitable protocol for communicating between the vehicle 100 and other entities in the cloud environment. Moreover, the communication system 127, in one arrangement, further communicates according to a protocol, such as global system for mobile communication (GSM), Enhanced Data Rates for GSM Evolution (EDGE), Long-Term Evolution (LTE), 5G, or another communication technology that provides for the vehicle 100 communicating with various remote devices (e.g., a cloud-based server). In any case, the request feedback system 126 can leverage various wireless communication technologies to provide communications to other entities, such as members of the cloud-computing environment.

With reference to FIG. 2, one embodiment of the request feedback system 126 of FIG. 1 is further illustrated. The request feedback system 126 is shown as including a processor 101 from the vehicle 100 of FIG. 1. Accordingly, the processor 101 may be a part of the request feedback system 126, the request feedback system 126 may include a separate processor from the processor 101 of the vehicle 100, or the request feedback system 126 may access the processor 101 through a data bus or another communication path that is separate from the vehicle 100. In one embodiment, the request feedback system 126 includes a memory 232 that stores a direction module 234 and a control module 236. The memory 232 is a random-access memory (RAM), read-only memory (ROM), a hard-disk drive, a flash memory, or another suitable memory for storing the modules 234 and 236. The modules 234 and 236 are, for example, computer-readable instructions that, when executed by the processor 101, cause the processor 101 to perform the various functions disclosed herein. In alternative arrangements, the modules 234 and 236 are independent elements from the memory 232 that are, for example, comprised of hardware elements. Thus, the modules 234 and 236 are alternatively application-specific integrated circuits (ASICs), hardware-based controllers, a composition of logic gates, or another hardware-based solution.

Moreover, in one embodiment, the request feedback system 126 includes the data store 118. The data store 118 is, in one embodiment, an electronic data structure stored in the memory 232 or another data storage device and that is configured with routines that can be executed by the processor 101 for analyzing stored data, providing stored data, organizing stored data, and so on. Thus, in one embodiment, the data store 118 stores data used by the modules 234 and 236 in executing various functions. The request feedback system 126 is shown as including a data store 118 from the vehicle 100 of FIG. 1. Accordingly, data store 118 may be a part of the request feedback system 126, the request feedback system 126 may include a separate data store from the data store 118 of the vehicle 100, or the request feedback system 126 may access the data store 118 through a data bus or another communication path that is separate from the vehicle 100.

In one embodiment, the data store 118 stores the sensor data 228. In general, the sensor data 228 is any data collected by the sensor system 102 of the vehicle 100. Of particular relevance, the sensor data 228 may be that data from which a user request issued by an occupant within the vehicle or a human bystander is identified. That is, a vehicle 100 may be equipped with any number of sensors within the cabin and external to the cabin. These sensors collect data, including user requests issued by an occupant of the vehicle 100 or by a human outside but near the vehicle 100. As an example, an occupant may issue a verbal query. For example, a user may state, “What is the price of gas at the gas station to my right?”

In an example, the user may issue a non-verbal request, such as a gesture response to a prompt displayed on a vehicle human-machine interface (HMI). For example, the HMI may display text that states, “On which side of the road would you like to find a convenience store?”. The occupant may respond to this prompt by pointing to a particular side of the road. In another example, the user may issue a query with verbal and non-verbal components. For example, a vehicle driver may state, “What is that restaurant right there?” while pointing and/or looking toward a particular establishment. In any case, a user request to a vehicle system may include verbal and non-verbal components, which may be detected by the vehicle sensors and subsequently analyzed by the direction module 234. In this example, the sensor data 228 includes the sensor output collected during the operation of the vehicle 100, which sensor output may capture the user-issued request features identified in subsequent operations of the request feedback system 126.

Still further, as described below, in some examples, the request feedback system 126 may provide feedback (i.e., via the illumination of particular locations along an illumination strip 238) based on the location of the source of the user request. Accordingly, in some examples, the sensor data 228 may include occupant localizing sensor output. In an example, this may include the microphone and/or camera data as described above. In other examples, the source localization sensor data may include data from other sources, such as a seat sensor or a thermal imaging camera, each of which can capture data that indicates the location of a source of a user request. Specific examples of sensors that may capture the user request-based actions of an occupant include cameras, radar sensors, LiDAR sensors, seat occupancy sensors, thermal imaging cameras, infrared cameras, time-of-flight cameras, and microphones, among others.

In one embodiment, the data store 118 stores the sensor data 228 along with, for example, metadata that characterizes various aspects of the sensor data 228. For example, the metadata can include location coordinates (e.g., longitude and latitude), relative map coordinates or tile identifiers, time/date stamps from when the separate sensor data 228 was generated, and so on.

In one embodiment, the data store 118 includes various lookup tables 230 that map directions specified in a user request to particular locations along the illumination strip 238. For example, the direction module 234 may identify a direction specified in the user request. In some examples, the direction may be specified via verbal and/or non-verbal modalities. In either case, with the direction specified, the request feedback system 126 may illuminate elements of the illumination strip 238 that correspond to the specified direction. For example, a vehicle occupant may look toward a specific direction and ask, “What is that?”. The request feedback system 126 may desire to illuminate a portion of the illumination strip 238 that corresponds to where the occupant is looking to let the driver know that their user request and the object they are inquiring about are correctly recognized. Accordingly, the lookup table 230 includes a mapping between the specified direction and the portion of the illumination strip 238 that is to be illuminated that corresponds to the specified direction.

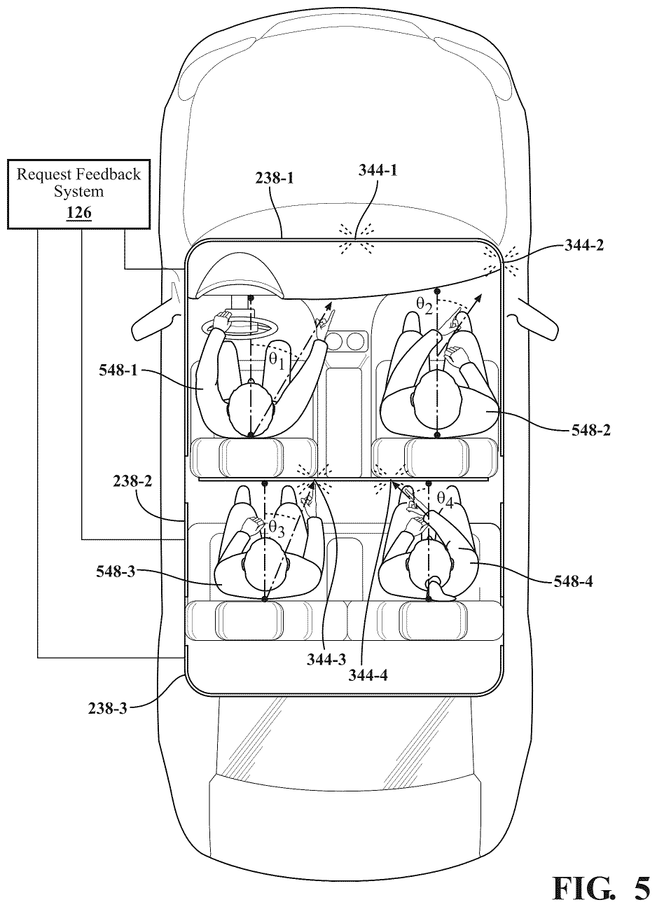

Specifically, each lighting element of the illumination strip 238 may be identified by a particular address indicating its location along the illumination strip 238. The lookup table 230 may include a mapping between 1) angles of the specified direction and 2) associated illumination element addresses. For example, a vehicle driver may point to a location 30 degrees to the right of a reference axis, which reference axis may be extending directly in front of the driver. The direction module 234 may detect this 30-degree angle of the user's arm. The lookup table 230 may indicate those element addresses of the illumination strip 238 that correspond to the vehicle driver's pointing direction. Based on the lookup table 230, the request feedback system 126 may illuminate a portion of the illumination strip 238 that coincides with where the user is pointing based on the mapped illumination element location addresses. A specific example of the mapping of the lookup table 230 is provided below in connection with FIG. 5.

In some examples, the data store 118 includes multiple lookup tables 230, with different lookup tables 230 associated with different source locations. For example, as depicted in FIG. 5, a driver in a front driver-side seat pointing 30 degrees to their right may be associated with a different portion of the illumination strip 238 than a portion of the illumination strip associated with an occupant of the front passenger-side seat pointing 30 degrees to their right. Accordingly, a single lookup table 230 that does not account for source location may improperly illuminate the illumination strip 238. Accordingly, as described in greater detail below, the request feedback system 126 may identify a location of the source of the user request and may select a lookup table 230 that is associated with that source location.

The direction module 234, in one embodiment, includes instructions that cause the processor 101 to identify a direction specified in a user request, which user request is captured by a sensor in a vehicle 100. As described above, at any point in time, an occupant in a vehicle 100 or an individual in the vicinity of the vehicle 100 may have a question regarding a location in the surrounding environment of the vehicle 100 or may initiate a control command for a vehicle system. The vehicle 100 may include systems capable of responding to the question and triggering an action of the vehicle based on the control command. However, to build user confidence in the response system, the request feedback system 126 may provide visual feedback to the user that the vehicle system correctly assessed the nature of the user request. That is, the request feedback system 126 visually indicates that the direction specified in the user request was properly received and that any associated output is correctly associated with the direction in the user request.

In one example, the direction module 234 includes instructions that cause the processor 101 to identify the direction from audio captured by a microphone of the vehicle 100. That is, it may be that the user request is verbal. In this example, an audio processor of the direction module 234 may process the audio captured by the microphone to identify at least a part of a user request. For example, certain keywords, tones, and inflections may indicate that a verbal utterance is a question. Example keywords include “what” and “where.” The audio processor of the direction module 234 may be capable of analyzing an audio signature to identify these keywords within captured audio. Similarly, the audio processor of the direction module 234 may be able to analyze the pitch, volume, tone, and inflection of captured audio, which may also be indicative of a query. While particular reference is made to query-based audio analysis, a similar analysis may be done to identify and classify an utterance as a control command. In an example, the direction module 234 may identify the direction specified in the user request based on verbal components alone. That is, the user request may be gesture-less. In other examples, as described below, the location module 234 may identify the direction specified in the user request based on verbal and non-verbal cues.

In one example, the direction module 234 includes instructions that cause the processor 101 to identify the direction from a gesture captured by a sensor of the vehicle 100. In general, a sensor refers to any sensor that captures the movement of an individual. Examples of sensors include cameras, LiDAR sensors, radar sensors, infrared sensors, time-of-flight cameras, thermal imaging cameras, etc. From the output of these sensors, the direction module 234 may identify a gesture of the source of the user request. For example, the direction module 234 may include a processor that can identify objects or portions of objects and track the movement of the objects through space. Accordingly, the processor of the direction module 234 may process the output of the sensors (e.g., cameras) to track the movement of the user and/or the user's body parts, which may indicate a gesture.

The identified gesture may be of a variety of types. For example, a user may move their head and/or eyes while looking at a particular object outside the vehicle 100. In this example, the direction module 234 may track the user's head and/or eye movement to identify the direction of the user's gaze. The direction of the user's gaze may be the direction specified in the user request and may serve as a trigger for illumination strip 238 illumination. In a specific example, the direction module 234 may identify a vector or angle of the user's gaze direction.

In another example, a user may point with their hand at a particular object outside of the vehicle 100. In this example, the processor of the direction module 234 may identify the arm of the user and generate a vector indicating the pointing direction. The direction module 234 may identify a vector or angle of the user's arm. The location where the user is pointing may be the direction specified in the user request, which serves as a trigger for illumination strip 238 illumination.

As with a verbal-based user request, in an example, the request feedback system 126 may provide visual feedback based on the non-verbal component alone. For example, a screen may display text with a prompt for a user to specify the direction of an object of interest non-verbally (i.e., with an eye/head gesture or a pointing gesture). Responsive to the prompt, a user may make an arm/hand gesture. In this example, the direction module 234 may identify the direction specified in the user request without audio input.

In another example, as described above, a user request may have verbal and non-verbal components. For example, the driver may ask, “What is that?” while looking or pointing at an object/establishment in the environment outside of the vehicle 100. In this example, an audio processor may analyze the captured audio to identify the utterance as a query (for example, based on keyword, tone, and/or inflection analysis), and another processor may analyze the captured images to identify the direction of the object of the user request. Accordingly, the direction module 234 may identify an interaction as comprising a user request and may identify the direction specified in the user request.

In one example, identifying a direction may include generating an angle of a gesture of the user. For example, a user's head/eye may have a gaze direction, and/or the user's arm, hand, and finger may have a pointing direction. In a gaze-direction example, a processor may identify the head pose and/or gaze direction and determine the angle from a reference axis, that indicates a direction where the user is looking. In the example of a physical gesture, a sensor processor (e.g., an image processor) may determine the angle along the user's arm, hand, and finger, which angle represents the direction specified in the user request.

Accordingly, the direction module 234, in one embodiment, controls the respective sensors to provide the data inputs in the form of the sensor data 228. Additionally, while the direction module 234 is discussed as controlling the various sensors to provide the sensor data 228, in one or more embodiments, the direction module 234 can employ other techniques to acquire the sensor data 228 that are either active or passive. For example, the direction module 234 may passively sniff the sensor data 228 from a stream of electronic information provided by the various sensors to further components within the vehicle 100. Moreover, the direction module 234 can undertake various approaches to fuse data from multiple sensors when providing the sensor data 228. Thus, the sensor data 228, in one embodiment, represents a combination of perceptions acquired from multiple sensors.

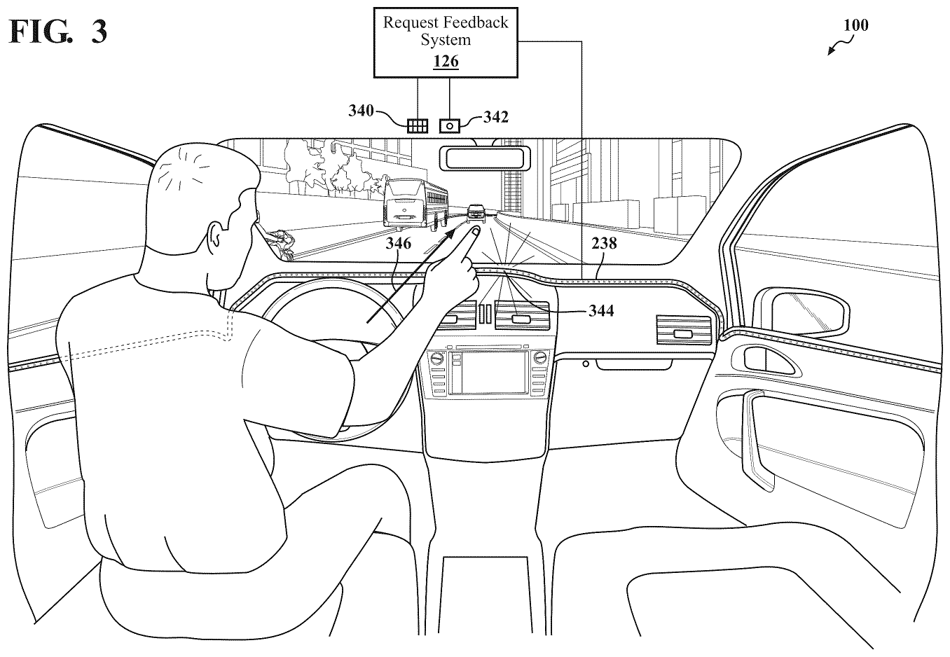

The direction module 234, in one embodiment, includes instructions that cause the processor 101 to map the direction specified in the user request to a corresponding location along an illumination strip 238 encompassing a portion of the vehicle 100. The illumination strip 238 may be of various types, such as a strip of light-emitting diodes (LEDs) that wrap around an interior or exterior portion of the vehicle 100. For example, as depicted in FIG. 3, the illumination strip 238 may be a strip of LEDs embedded into, or attached to, the driver-side door, the dashboard, and the passenger-side door of the cabin of the vehicle 100. Each location along the illumination strip 238 (e.g., each LED within the LED array) may be individually addressable. Note that while particular reference is made to an LED-based illumination strip 238, the illumination strip 238 may be of various types.

As part of the mapping, the direction module 234 may identify an address on the illumination strip 238 that is associated with a particular direction specified in the user request. Specifically, this identification may be based on the lookup tables 230 described earlier, which may map direction angles to illumination strip 238 element addresses.

In addition to identifying the direction specified in a user request, the direction module 234 may also identify the location of the source of the user request. This may be based on the output of any number of sensors, including microphones, cameras, other sensors, and/or seat sensors. In an example, the location of the source may identify where in the vehicle 100 the occupant is seated. For example, via object recognition or audio source localization, the processor of the direction module 234 may determine where the source of a user request is located in the vehicle 100. For example, an audio processor of the direction module 234 may be able to analyze an audio source and identify the origin of an audio signal. As another example, an image processor of the direction module 234 may have the ability to not only identify an object but also localize the object within the environment or based on absolute coordinates. In either of these examples, the same sensors that capture data from which a user request is identified may also be used to identify the location of the source of the user request.

In another example, the sensor from which the location of the source is identified is different from the sensor from which a direction specified in a user request is identified. For example, the vehicle 100 may include pressure sensors within a seat. The output of the pressure sensors may indicate the seating location of an occupant.

In another example, the location of the source may be independent of the seating position within the vehicle 100. For example, a driver may be seated in a front driver-side seat but leaning towards the center of the vehicle 100. The change in the lateral position of the source of the user request may alter which portions of the illumination strip 238 should be illuminated. For example, a direction specified by a pointing direction of 45 degrees to the right of a driver seated vertically may be different than a direction specified by a pointing direction of 45 degrees to the right of a driver leaning towards the center of the vehicle. Accordingly, in either case, the lateral position of the source of the user request may define which portions of the illumination strip 238 are associated with particular user request-specified directions. Accordingly, the direction module 234 determines the location of the source of the user request as described above and selects a corresponding lookup table 230 that is associated with a particular location in the vehicle 100 (e.g., seat location, lateral position within a vehicle 100). With the appropriate lookup table 230 selected, the direction module 234 can identify the portion of the illumination strip 238 that is mapped to a particular user request-specified direction.

While particular reference is made to identifying the location of a source within the vehicle, similar principles may be implemented for a source of a user request outside of the vehicle 100. For example, while standing outside the vehicle 100 at a roadside scenic viewpoint, a user may request additional information from a vehicle system about a particular geological feature in the distance. In this example, using similar localization techniques (e.g., audio and/or image analysis), the direction module 234 may identify this source as an external source and select an appropriate lookup table 230 as described above.

In one approach, the direction module 234 implements and/or otherwise uses a machine learning algorithm to identify a user request or direction specified within a user request. In one configuration, the machine learning algorithm is embedded within the direction module 234, such as a convolutional neural network (CNN). Of course, in further aspects, the direction module 234 may employ different machine learning algorithms or implement different approaches for performing the detection of a direction in the user request, which can include deep convolutional encoder-decoder architectures, a multi-scale context aggregation approach using dilated convolutions, or another suitable approach that generates user request classifications and that identifies directions within the user request. Whichever particular approach the direction module 234, the direction module 234 provides an output that indicates a user request classification and a direction specified in the user request.

The request feedback system 126 also includes a control module 236 that includes instructions that, when executed by the processor 101, cause the processor 101 to activate an illumination element of the illumination strip 238. The activated illumination element is at the corresponding location of the illumination strip 238 which maps to the direction specified in the user request.

As described above, each illumination element of an illumination strip 238 is uniquely addressable and activatable. For example, the control module 236 may include a controller that activates/deactivates each illumination element via the transmission of an electrical signal. The control module 236 generates these electrical signals responsive to an indication from the direction module 238 via the mapping. That is, the direction module 238 may identify those illumination elements that are associated with a particular gesture direction and may send data to the control module 236 identifying such, for example, via element addresses. The control module 236 then transmits an activation electrical signal to the corresponding illumination elements via the communication system 127. In this example, this portion of the communication system 127 may include electrical traces to each illumination element such that the control module 236 may individually activate/deactivate each illumination element, as indicated by the output of the direction module 234.

In an example, the control module 236 may control the illumination characteristics of the illumination elements. That is, the illumination strip 238 may include an array of elements that 1) emanate light in a particular way or 2) emanate light in multiple selectable ways. In either case, the illumination elements may be controlled to emanate light in a particular way based on various criteria. Specific examples of illumination characteristics that may be controlled include brightness, color, strobing pattern, and strobing intensity, among others.

As an example, a color and/or strobing pattern may be selected based on the proximity of the object associated with the direction specified in the user request. For example, a higher frequency strobing pattern or a bright attention-capturing color (e.g., red as opposed to green) may be implemented when the object associated with the user request-specified direction is closer to the vehicle 100. As another example, the brightness of the illumination may be based on a time of date. For example, a brighter light may be emitted in the daytime to provide a higher contrast with the brighter ambient light. As another example, the color, brightness, strobing pattern, and strobing intensity may be selected based on a user preference, whether learned over time or input manually.

As yet another example, the color, brightness, or other illumination characteristic may be selected based on the location of the source of the user request. For example, when it is determined that the source is in the driver-side seat of the vehicle 100, the illumination element may emit a red light. An illumination element may emit a green light when the source is an occupant in a passenger-side seat of the vehicle 100. A location-based emanation characteristic may allow the request feedback system 126 to receive and differentiate user requests from multiple users, sometimes received simultaneously.

As such, the request feedback system 126 receives sensor output, detects a user request (e.g., a user request for information or a user request for action) in the captured output (whether verbal-based, gesture-based, or both), detects a direction specified in and/or associated with the user request, and detects a location of the source of the user request. The request feedback system 126 then provides a visual indicia specific to the user request by activating illumination elements near the direction specified in the user request.

In one or more configurations, the request feedback system 126 implements one or more machine learning algorithms. As described herein, a machine learning algorithm includes but is not limited to deep neural networks (DNN), including transformer networks, convolutional neural networks, recurrent neural networks (RNN), etc., Support Vector Machines (SVM), clustering algorithms, Hidden Markov Models, and so on. It should be appreciated that the separate forms of machine learning algorithms may have distinct applications, such as agent modeling, machine perception, and so on.

Moreover, it should be appreciated that machine learning algorithms are generally trained to perform a defined task. Thus, the training of the machine learning algorithm is understood to be distinct from the general use of the machine learning algorithm unless otherwise stated. That is, the request feedback system 126 or another system generally trains the machine learning algorithm according to a particular training approach, which may include supervised training, self-supervised training, reinforcement learning, and so on. In contrast to training/learning of the machine learning algorithm, the request feedback system 126 implements the machine learning algorithm to perform inference. Thus, the general use of the machine learning algorithm is described as inference.

FIG. 3 depicts an environment-facing view of a request feedback system 126 acknowledging the receipt of a direction specified in a user request. As described above, the request feedback system 126 may acquire data from various vehicle sensors, each of which may capture data from which a user request may be extracted. Specifically, the vehicle 100 may include a microphone 340 and a sensor 342 disposed within the vehicle 100. As described above, the sensor 342 may be of various types, including an RGB camera, an IR camera that may be used in low-light conditions, a time-of-flight camera, a thermal imaging camera, or any other type of sensor or combination of sensors.

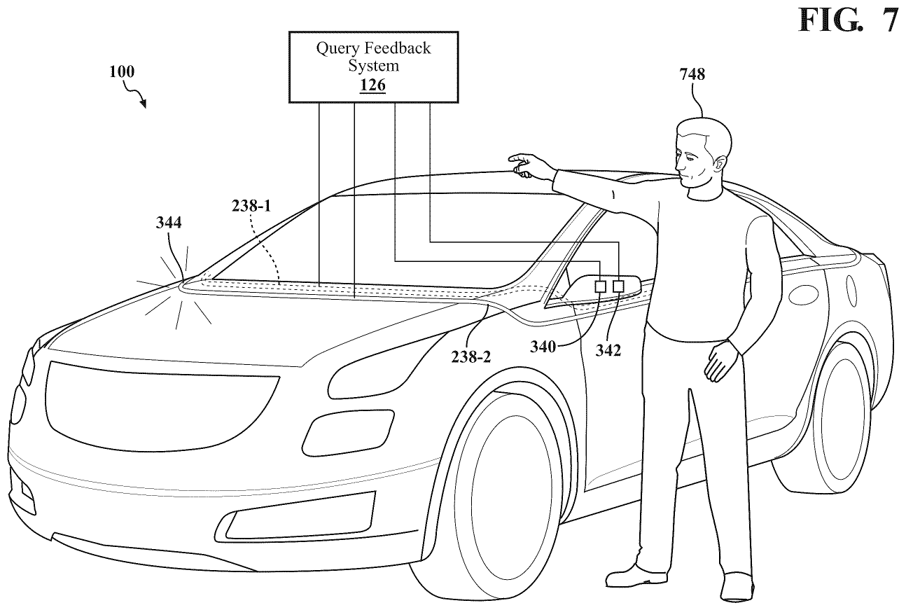

As described above, the direction module 234 of the request feedback system 126 may analyze the output of the microphone 340 and sensor 342 individually or collectively to identify a user request from an occupant of the vehicle 100 (or from a user outside of the vehicle 100 as depicted in FIG. 7) and identify a direction 346 indicated in the user request. For example, a driver may point in a particular direction as indicated in FIG. 3. The direction module 234 may identify the angle of the gesture as described above via image processing. Responsive to this gesture, which may be interpreted as a user request for information, the request feedback system 126 may activate an illumination element 344 at a location along the illumination strip 238 corresponding to the gesture direction 346. In an example, the illumination element 344 that is activated is an illumination element at a point along the illumination strip 238 that intersects a vector between the user and an object of interest.

As described above, the user request may be a non-verbal response to a prompt from a vehicle system. For example, an infotainment screen may display the text, “You need gasoline; which side of the road would you like to navigate to for a convenience station?” The user may respond via an eye or arm gesture rather than responding on the infotainment screen with a direction indication. In this example, the request feedback system 126 may activate the illumination element 344 based on the non-verbal response to the prompt.

In another example, a vocalization may accompany the gesture. The audio of the vocalization may be analyzed to 1) identify the statement as a user request, which user request classification may trigger activation of a corresponding illumination element 344, and/or 2) identify the direction in the user request.

As another example, the user request may be verbal without a non-verbal component. In this example, the audio itself may provide the direction of the user request. For example, it may be accepted parlance to refer to locations in the environment by associated positions of an hour hand of a clock. Accordingly, a user may say, “What's that at 2 o'clock in front of me?” with 2 o'clock indicating a direction approximately 60 degrees to the right of the center of the source. Based on this audio output alone, the direction module 234 may identify a direction as described above.

In any case, the request feedback system 126 may identify the direction specified in the user request and identify the illumination elements 344 that are associated with the direction, which association may be made based on consultation of the lookup table 230. For example, the associated illumination element 344 may be an illumination element that falls along a representative vector between the user and the object of the user's focus as manifested by the user's gesture and/or gaze. Put another way, the direction may be a bearing between the object of the user's gesture and/or gaze. As described above, the lookup table 230 may index illumination element 344 addresses based on an angle associated with the direction. Accordingly, when the direction of a user request is indicated as having a particular angle, an illumination element 344 identified in the lookup table 230 as being associated with that particular angle is activated by transmitting an electrical signal via the control module 236.

Note that in an example, the illumination strip 238 may span a field of view of the driver. That is, the illumination strip 238 may cover approximately 180 degrees of the front portion of the cabin of the vehicle 100. For example, as depicted in FIG. 3, the illumination strip 238 may extend across a front driver-side door, a dashboard, and a front passenger-side door of the vehicle 100. In other examples, the illumination strip 238 may fully encompass the interior of the cabin, for example, extending across rear doors and a rear portion of the interior cabin.

In another example, the illumination strip 238 or another illumination strip may span a field of view of passengers in the rear seats of the vehicle 100. In this example, passing across a rear driver-side door, interior elements of the vehicle 100, and a rear passenger-side door of the vehicle 100.

In an example, the illumination strip 238 may be integrated with the vehicle 100, that is, the illumination strip 238 may be formed as part of the vehicle 100 during manufacturing. In another example, the illumination strip 238 is an accessory item that may be acquired separately by a user and added to the vehicle 100. As described above, it may be that the illumination strip 238 is visible from the exterior of the vehicle 100. In this example, as depicted in FIG. 7 below, the request feedback system 126 may activate a particular illumination element 344 on the interior illumination strip 238 responsive to a user request originating from outside the vehicle 100, and the user may be able to receive confirmation of their request by viewing the illumination element 344 on the interior of the vehicle 100.

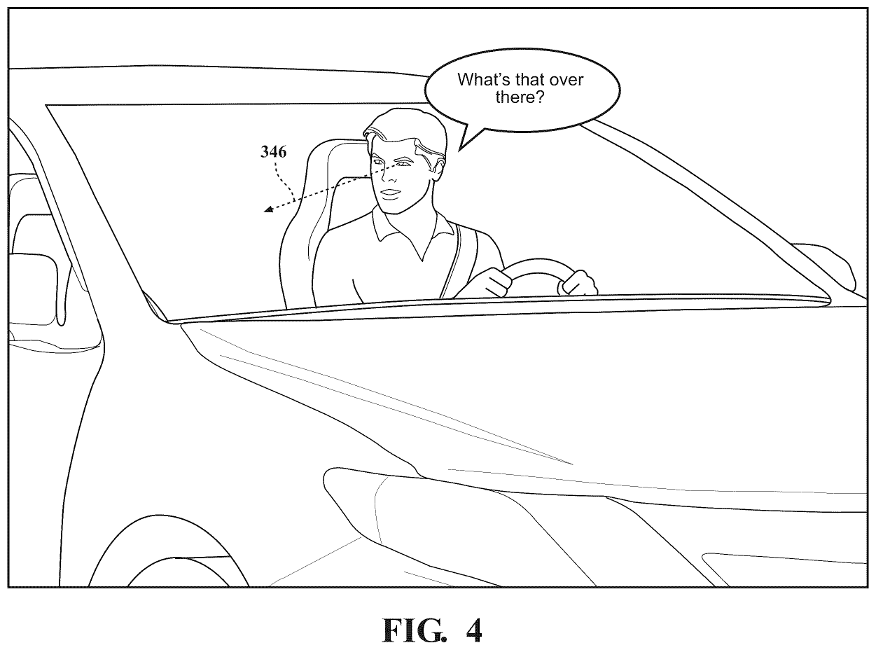

FIG. 4 depicts a driver-facing view of a request feedback system 126 acknowledging the receipt of a direction specified in a user request. As described above, the direction module 234 of the request feedback system 126 may analyze the output of the microphone 340 and sensor 342 individually or collectively to identify a user request from an occupant of the vehicle 100 (or from a surrounding user as depicted in FIG. 7) and identify a direction indicated in the user request. In the example depicted in FIG. 4, the driver is looking at a direction of interest and asking a question. In this example, the direction module 234 may include an image processor that can infer a gaze direction based on object analysis. For example, via pixel analysis, an image processor of the direction module 234 may ascertain where the driver is looking (i.e., a gaze direction) for example by detecting the location of pupils of the eye relative to other portions of the eye. This gaze direction may be the direction 346 of interest specified in the user request. In an example, the determination of gaze direction may be further aided by a determined head pose/gesture of the occupant. For example, the chin of a user looking to the right (i.e., left in the driver-facing environment depicted in FIG. 4) may be angled to the right. In this example, the direction module 234 of the present specification may perform pixel analysis to identify the chin of the source of the user request and its direction to aid in identifying the direction 346 of interest of the user request.

As described above, the direction module 234 may identify the angle of the gesture via image processing. Responsive to this gesture, which may be interpreted as a user request, the request feedback system 126 may activate an illumination element 344 at a location along the illumination strip 238 that corresponds to the gesture direction.

As described above, the user request may be a non-verbal response to a prompt from a vehicle system. For example, an infotainment screen may display the text, “You need gasoline; which side of the road would you like to navigate to for a convenience station?” Rather than responding on the infotainment screen with a direction indication, the user may look in a particular direction as a response to the prompt. In this example, the request feedback system 126 may illuminate based on the non-verbal response to the prompt.

In another example, a vocalization may accompany the gesture. The audio of the vocalization may be analyzed to 1) identify the statement as a user request, which user request classification may trigger activation of a corresponding illumination element 344, and/or 2) identify the direction in the user request.

In any case, the request feedback system 126 may identify the direction specified in the user request and identify the illumination elements 344 that are associated with the direction, which association is indicated in the lookup table 230 as described above.

FIG. 5 depicts a schematic of a request feedback system 126 acknowledging the receipt of a direction specified in a user request. For simplicity, the sensors of the vehicle 100 have been omitted to more clearly depict other elements. As described above, the arrangement of illumination strips 238-1, 238-2, and 238-3 may take various forms. FIG. 5 illustrates various example illumination strip configurations. For example, a first illumination strip 238-1 may span a frontward field of view (e.g., at least 180 degrees) of front seat passengers 548-1 and 548-2 around a front portion of a cabin of the vehicle 100. In another example, a second illumination strip 238-2 may span a frontward field of view (e.g., at least 180 degrees) of rear seat passengers 548-3 and 548-4 around a rear portion of the cabin of the vehicle 100. A third illumination strip 238-3 may be disposed behind the passengers 548-1, 548-2, 548-3, and 548-4. The vehicle 100 may include any combination of these illumination strips. For example, a vehicle 100 may include the first illumination strip 238-1 and the third illumination strip 238-3 and may combine such into a single illumination strip, such that a single illumination strip surrounds the entire cabin of the vehicle 100. Note that in this example, the request feedback system 126, and more specifically the direction module 234, may identify a rearward gesture, such as a driver looking over their shoulder or pointing to the rear of the vehicle 100, and may illuminate an illumination element on the third illumination strip 238-3 that is behind the driver. As an example, a driver (i.e., a front driver-seat first passenger 548-1) may point to the rear of the vehicle 100 with a command (i.e., a requested action) of “open the trunk.” Responsive to this command, a vehicle system unlatches and opens the vehicle trunk. In this example, the request feedback system 126 may activate an illumination element on the third illumination strip 238-3 to indicate to the front driver-seat first passenger 548-1 that the command was received.

In any case, each passenger 548-1, 548-2, 548-3, and 548-4 may be a source of a user request and an object of receipt acknowledgment. That is, the request feedback system 126 may recognize and acknowledge multiple direction inputs. In one example, the illumination characteristics of a particular illumination element 344-1, 344-2, 344-3, and 344-3 may be set based on the source of the user request to which it is associated. For example, a first illumination element 344-1 may illuminate in a first color when a user request is received from a first passenger 548-1 that is in a front driver-side seat location. A second illumination element 344-2 may illuminate in a second color when a user request is received from a second passenger 548-2 in a front passenger-side seat location. A third illumination element 344-3 may illuminate in a third color when a user request is received from a third passenger 548-3 in a rear driver-side seat. A fourth illumination element 344-4 may illuminate in a fourth color when a user request is received from a fourth passenger 548-4 in a rear driver-side seat.

An example operation to identify a direction specified in a user request from a source in the vehicle 100 will now be provided. It should be noted that a similar process may be executed for a source outside of the vehicle 100, with the user request being captured by external sensors and/or external microphones. As described above, the illumination element 344 may be activated based on the location of the source of the user request. For example, a first passenger 548-1 in a front driver-side seat and a second passenger 548-2 in a front passenger-side seat may each gesture (in this example via pointing) in approximately the same direction relative to a reference axis. However, based on their seating location, different illumination elements 344-1, 344-2 may be mapped to these different direction angles. Accordingly, the direction module 234 may include instructions that cause the processor 101 to identify the source location of a source of the user request. As described above, this may be based on the output of various sensors, including microphone output, sensor output, and other sensor outputs such as seat pressure sensors. In any case, the direction module 234 may include instructions that cause the processor 101 to select an associated lookup table 230 from a set of lookup tables based on the source location. As described above, the selected lookup table 230 includes a mapping between illumination elements 344 to activate and an angle for any gesture (e.g., eye/head gesture and/or pointing gesture).

In addition, the direction module 234 may include instructions that cause the processor 101 to map the angle of the gesture relative to a reference axis. In an example, the reference axis may generally be in a forward direction perpendicular to the source's body. More particularly, the reference axis may be a reference axis that is perpendicular to a line between the source's shoulders. FIG. 5 depicts a reference axis for each passenger 548 in the vehicle 100. In generating the angle, the direction module 234 may include processors that 1) locate objects, such as passenger arms, eyes, and/or heads, and 2) via image processing and pixel analysis, identify an angle of the arm relative to the reference axis and/or an angle of a gaze direction of the occupant relative to the reference axis. For example, the direction module 234 may determine 1) a first gesture angle, θ₁, associated with a gesture of the front driver-side passenger 548-1, 2) a second gesture angle, θ₂, associated with a gesture of the front passenger-side passenger 548-2, 3) a third gesture angle, θ₃, associated with a gesture of the rear driver-side passenger 548-3, and 4) a fourth gesture angle, θ₄, associated with a gesture of the rear passenger-side passenger 548-4. Note that in some examples, signs (either positive or negative) may be associated with angles on either side of the reference axis. For example, the first gesture angle, θ₁, the second gesture angle, θ₂, and the third gesture angle, θ₃, may all have a positive sign by virtue of being on the right of the reference axis. By comparison, the fourth gesture angle, θ₄, may have a negative sign by virtue of being on the left side of the respective reference axis.

In any case, the direction module 234 identifies, based on a selected lookup table 230, illumination elements 344 to be activated based on the mapping between the angle of the gesture and an illumination element address as described above. Note that in some examples, a lookup table 230 may not include entries for each gesture angle but may instead include entries for discrete gesture angles. In this example, the direction module 234 may interpolate between particular entries to identify which illumination elements 344 should be activated for a given gesture angle.

Accordingly, the request feedback system 126 thus provides visual feedback to a user request issued from passenger(s) 546 in a vehicle 100 so that the passenger(s) 546 may have confidence that their user request was received correctly and is being responded to by some vehicle system, whether the user request is a user request for information with the information being provided by a vehicle system or whether the user request is a user request for action (i.e., a command) with the command being executed by a vehicle system.

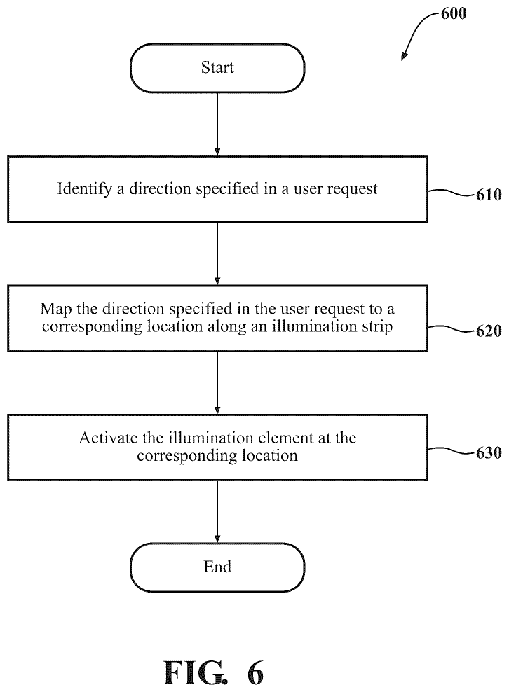

Additional aspects of acknowledging the receipt of a direction in a user request will be discussed in relation to FIG. 6. FIG. 6 illustrates a flowchart of a method 600 that is associated with acknowledging the receipt of a direction in a user request. Method 600 will be discussed from the perspective of the request feedback system 126 of FIGS. 1-5. While method 600 is discussed in combination with the request feedback system 126, it should be appreciated that the method 600 is not limited to being implemented within the request feedback system 126 but is instead one example of a system that may implement the method 600.

At 610, the direction module 234 identifies a direction specified in a user request, the location being in the surrounding environment of the vehicle 100. Specifically, the direction module 234 controls the sensor system 102 to acquire the sensor data 228. In one embodiment, the direction module 234 controls a sensor 342 and a microphone 340 to observe individuals in the vehicle 100 and/or the surrounding environment. As part of controlling the sensors to acquire the sensor data 228, it is generally understood that the sensors acquire the sensor data 228 of a region inside the vehicle 100 and, in some cases, surrounding the vehicle 100.

Moreover, in further embodiments, the direction module 234 controls the sensors to acquire the sensor data 228 at successive iterations or time steps. Thus, the request feedback system 126, in one embodiment, iteratively executes the functions discussed at blocks 610-630 to acquire the sensor data 228 and provide information therefrom. Furthermore, the request feedback system 126, in one embodiment, executes one or more of the noted functions in parallel for separate observations in order to maintain updated perceptions.

At 620, the direction module 234 maps the direction specified in the user request to a corresponding location along an illumination strip 238 that encompasses at least a portion of the vehicle 100. For example, as depicted in FIGS. 3-5, an illumination strip 238 may encompass at least a portion of the cabin of the vehicle 100. Particular illumination elements 334 along the illumination strip 238 are activated, which particular illumination elements 334 correspond to a direction indicated in a user request, which user request may be a user request for information (i.e., a query) or a user request for action (i.e., a command). As described above, such mapping includes identifying an angle associated with the user request and identifying, via a lookup table 230, an illumination element address that is associated with the identified angle indicated in the user request.

At 630, the control module 236 activates an illumination element 344 of the illumination strip 238. Specifically, the control module 236 activates an illumination element 344 that is at the corresponding location along the illumination strip 238 that maps to the direction specified in the user request. As described above, the corresponding location may be a location where the illumination strip 238 intersects with the bearing between the user and the object of the user's focus, with the object of the user's focus being determined by a pointing gesture, a head/eye gesture, and/or a verbal cue. In any case, the control module 236 includes instructions that cause the processor 101 to activate the illumination element 344 to emanate light based on at least one of a proximity of the direction in the user request to the vehicle 100, environmental conditions surrounding the vehicle 100, a user preference, or a seating location of a source of the user request.

For example, a higher frequency strobing pattern or a brighter color (e.g., red instead of green) may be used when the object associated with the user request-specified direction is closer to the vehicle 100. As another example, the brightness of the illumination element may be based on a time of date. For example, a brighter light may be emitted in the daytime to provide a higher contrast with the brighter ambient light. As another example, the color, brightness, strobing pattern, and strobing intensity may be selected based on a user preference, whether learned over time or input manually.

As yet another example, the color, brightness, or other illumination characteristic may be selected based on the location of the source of the user request. For example, when it is determined that the source is in the driver-side seat of the vehicle 100, the illumination element may emit a red light. An illumination element may emit a green light when the source is an occupant in a passenger-side seat of the vehicle 100. A location-based emanation characteristic may allow the request feedback system 126 to receive and differentiate location-specifying queries from multiple users, sometimes simultaneously.

As such, the request feedback system 126 provides user focus-based feedback to indicate to a user that their user request for information or action was received by the vehicle and a direction indicated in the user request was received correctly such that the user may have confidence in the responsive information or action aligns with their intent.

FIG. 7 depicts a view of a request feedback system 126 acknowledging receipt of a user request from a source external to the vehicle 100. As depicted in previous figures, the direction module 234 may include instructions that cause the processor 101 to identify a source inside the vehicle 100 (i.e., passengers/occupants of the vehicle 100). In this example, the direction module 234 may include instructions that cause the processor 101 to identify a source (e.g., an individual 748) outside of the vehicle 100. In this example, the modules 234 and 236 may operate similarly as described above. Specifically, the vehicle 100 may include externally mounted microphone(s) 340 and sensor(s) 342, which capture data from which a user request may be extracted, which user request may be a user request for information or a user request for an action. From this sensor data 228, the direction module 234 identifies a direction indicated in the user request and identifies those illumination elements 344 that are to be activated based on the identified direction. Note that in this example, the vehicle 100 may include a first illumination strip 238-1 on the inside of the vehicle 100 as described above, which may be visible from outside the vehicle 100. This first illumination strip 238-1 may be activated as described above and may be visible to the individual 748 from the outside of the vehicle 100.

In an example, an additional illumination strip (e.g., a second illumination strip 238-2) may be on the outside of the vehicle 100 and, as described above, may encompass at least 180 degrees of the outside of the vehicle 100. Similarly, in this example, an illumination element 344 that falls along the bearing between the user and an object of the user's focus may be activated to provide visual feedback that the user request was correctly and accurately received and processed.

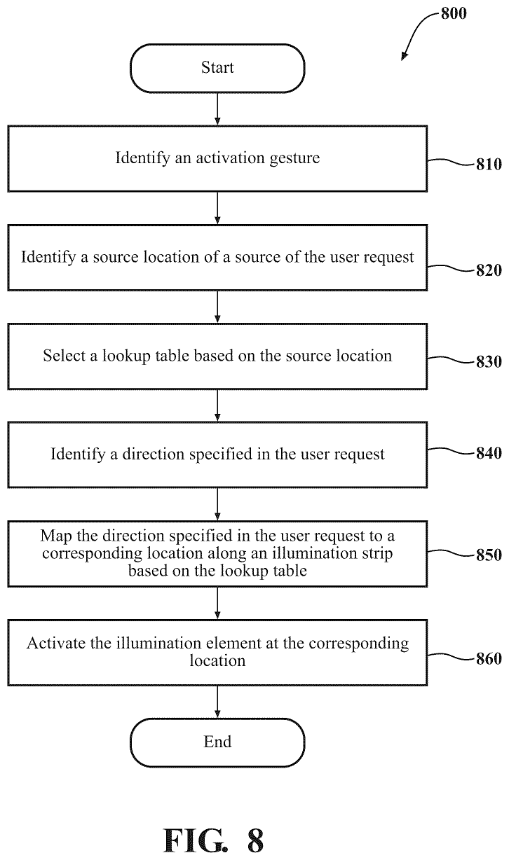

FIG. 8 illustrates a flowchart for one embodiment of a method 800 that is associated with acknowledging receipt of a user request. At 810, the request feedback system 126 may cause the processor 101 to identify an activation gesture that triggers the identification of the direction specified in a user request. That is, in some examples, rather than being triggered by a detected user request, an initialization action may trigger the request feedback system 126. In an example, the initialization action may be a particular gesture. For example, a user may state, “What is that over there?” and execute a particular gesture, such as performing a “poking” motion with their finger. This poking motion may be the activation gesture that triggers the request feedback system 126 to activate a corresponding illumination element 344. Relying on an activation gesture may differentiate a user request to a vehicle system from a user's request or query to another user in the vehicle 100. For example, a driver may ask a passenger in the vehicle, “Did you see that over there?” while pointing. Such a query may not necessarily be a request of a vehicle system.

At 820, the direction module 234 may identify the location of a source of the user request. As described above, the location of the source may define which illumination element 344 is to be activated. The source of the user request may be identified in various ways, as described above, by relying on different sensors. With a source location identified, at 830, the direction module 234 may select an associated lookup table 230 based on the source location, and at 840, it may identify a direction specified in the user request as described.

At 850, the direction module 234 may map the direction specified in the user request to a corresponding location along the illumination strip as described above, with the corresponding location being an intersection between the illumination strip 238 and the bearing angle of the user's focus as indicated by a direction in the user request, which indication may be verbal and/or non-verbal (e.g., a head gesture, an eye gesture, and/or a pointing gesture). The control module 236 may then, at 860, activate the illumination element 344 at the corresponding location so that a user may receive visual feedback that their user request is accurately processed.

FIG. 1 will now be discussed in full detail as an example environment within which the system and methods disclosed herein may operate. In some instances, the vehicle 100 is configured to switch selectively between an autonomous mode, one or more semi-autonomous modes, and/or a manual mode. “Manual mode” means that all of or a majority of the control and/or maneuvering of the vehicle is performed according to inputs received via manual human-machine interfaces (HMIs) (e.g., steering wheel, accelerator pedal, brake pedal, etc.) of the vehicle 100 as manipulated by a user (e.g., human driver). In one or more arrangements, the vehicle 100 can be a manually-controlled vehicle that is configured to operate in only the manual mode.

In one or more arrangements, the vehicle 100 implements some level of automation in order to operate autonomously or semi-autonomously. As used herein, automated control of the vehicle 100 is defined along a spectrum according to the SAE J3016 standard. The SAE J3016 standard defines six levels of automation from level zero to five. In general, as described herein, semi-autonomous mode refers to levels zero to two, while autonomous mode refers to levels three to five. Thus, the autonomous mode generally involves control and/or maneuvering of the vehicle 100 along a travel route via a computing system to control the vehicle 100 with minimal or no input from a human driver. By contrast, the semi-autonomous mode, which may also be referred to as advanced driving assistance system (ADAS), provides a portion of the control and/or maneuvering of the vehicle via a computing system along a travel route with a vehicle operator (i.e., driver) providing at least a portion of the control and/or maneuvering of the vehicle 100.

With continued reference to the various components illustrated in FIG. 1, the vehicle 100 includes one or more processors 101. In one or more arrangements, the processor(s) 101 can be a primary/centralized processor of the vehicle 100 or may be representative of many distributed processing units. For instance, the processor(s) 101 can be an electronic control unit (ECU). Alternatively, or additionally, the processors include a central processing unit (CPU), a graphics processing unit (GPU), an ASIC, a microcontroller, a system on a chip (SoC), and/or other electronic processing units that support operation of the vehicle 100.

The vehicle 100 can include one or more data stores 118 for storing one or more types of data. The data store 118 can be comprised of volatile and/or non-volatile memory. Examples of memory that may form the data store 118 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 118 is a component of the processor(s) 101. In general, the data store 118 is operatively connected to the processor(s) 101 for use thereby. The term “operatively connected,” as used throughout this description, can include direct or indirect connections, including connections without direct physical contact.

In one or more arrangements, the one or more data stores 118 include various data elements to support functions of the vehicle 100, such as semi-autonomous and/or autonomous functions. Thus, the data store 118 may store map data 119 and/or sensor data 122. The map data 119 includes, in at least one approach, maps of one or more geographic areas. In some instances, the map data 119 can include information about roads (e.g., lane and/or road maps), traffic control devices, road markings, structures, features, and/or landmarks in the one or more geographic areas. The map data 119 may be characterized, in at least one approach, as a high-definition (HD) map that provides information for autonomous and/or semi-autonomous functions.

In one or more arrangements, the map data 119 can include one or more terrain maps 120. The terrain map(s) 120 can include information about the ground, terrain, roads, surfaces, and/or other features of one or more geographic areas. The terrain map(s) 120 can include elevation data in the one or more geographic areas. In one or more arrangements, the map data 119 includes one or more static obstacle maps 121. The static obstacle map(s) 121 can include information about one or more static obstacles located within one or more geographic areas. A “static obstacle” is a physical object whose position and general attributes do not substantially change over a period of time. Examples of static obstacles include trees, buildings, curbs, fences, and so on.

The sensor data 122 is data provided from one or more sensors of the sensor system 102. Thus, the sensor data 122 may include observations of a surrounding environment of the vehicle 100 and/or information about the vehicle 100 itself. In some instances, one or more data stores 118 located onboard the vehicle 100 store at least a portion of the map data 119 and/or the sensor data 122. Alternatively, or in addition, at least a portion of the map data 119 and/or the sensor data 122 can be located in one or more data stores 118 that are located remotely from the vehicle 100.

As noted above, the vehicle 100 can include the sensor system 102. The sensor system 102 can include one or more sensors. As described herein, “sensor” means an electronic and/or mechanical device that generates an output (e.g., an electric signal) responsive to a physical phenomenon, such as electromagnetic radiation (EMR), sound, etc. The sensor system 102 and/or the one or more sensors can be operatively connected to the processor(s) 101, the data store(s) 118, and/or another element of the vehicle 100.

Various examples of different types of sensors will be described herein. However, it will be understood that the embodiments are not limited to the particular sensors described. In various configurations, the sensor system 102 includes one or more vehicle sensors 103 and/or one or more environment sensors. The vehicle sensor(s) 103 function to sense information about the vehicle 100 itself. In one or more arrangements, the vehicle sensor(s) 103 include one or more accelerometers, one or more gyroscopes, an inertial measurement unit (IMU), a dead-reckoning system, a global navigation satellite system (GNSS), a global positioning system (GPS), and/or other sensors for monitoring aspects about the vehicle 100.

As noted, the sensor system 102 can include one or more environment sensors 104 that sense a surrounding environment (e.g., external) of the vehicle 100 and/or, in at least one arrangement, an environment of a passenger cabin of the vehicle 100. For example, the one or more environment sensors 104 sense objects the surrounding environment of the vehicle 100. Such obstacles may be stationary objects and/or dynamic objects. Various examples of sensors of the sensor system 102 will be described herein. The example sensors may be part of the one or more environment sensors 104 and/or the one or more vehicle sensors 103. However, it will be understood that the embodiments are not limited to the particular sensors described. As an example, in one or more arrangements, the sensor system 102 includes one or more radar sensors 105, one or more LiDAR sensors 106, one or more sonar sensors 107 (e.g., ultrasonic sensors), and/or one or more cameras 108 (e.g., monocular, stereoscopic, RGB, infrared, etc.).

Continuing with the discussion of elements from FIG. 1, the vehicle 100 can include an input system 123. The input system 123 generally encompasses one or more devices that enable the acquisition of information by a machine from an outside source, such as an operator. The input system 123 can receive an input from a vehicle passenger (e.g., a driver/operator and/or a passenger). Additionally, in at least one configuration, the vehicle 100 includes an output system 124. The output system 124 includes, for example, one or more devices that enable information/data to be provided to external targets (e.g., a person, a vehicle passenger, another vehicle, another electronic device, etc.).

Furthermore, the vehicle 100 includes, in various arrangements, one or more vehicle systems 109. Various examples of the one or more vehicle systems 109 are shown in FIG. 1. However, the vehicle 100 can include a different arrangement of vehicle systems. It should be appreciated that although particular vehicle systems are separately defined, each or any of the systems or portions thereof may be otherwise combined or segregated via hardware and/or software within the vehicle 100. As illustrated, the vehicle 100 includes a propulsion system 110, a braking system 111, a steering system 112, a throttle system 113, a transmission system 114, a signaling system 115, and a navigation system 116.

The navigation system 116 can include one or more devices, applications, and/or combinations thereof to determine the geographic location of the vehicle 100 and/or to determine a travel route for the vehicle 100. The navigation system 116 can include one or more mapping applications to determine a travel route for the vehicle 100 according to, for example, the map data 119. The navigation system 116 may include or at least provide connection to a global positioning system, a local positioning system or a geolocation system.

In one or more configurations, the vehicle systems 109 function cooperatively with other components of the vehicle 100. For example, the processor(s) 101, the request feedback system 126, and/or automated driving module(s) 125 can be operatively connected to communicate with the various vehicle systems 109 and/or individual components thereof. For example, the processor(s) 101 and/or the automated driving module(s) 125 can be in communication to send and/or receive information from the various vehicle systems 109 to control the navigation and/or maneuvering of the vehicle 100. The processor(s) 101, the request feedback system 126, and/or the automated driving module(s) 125 may control some or all of these vehicle systems 109.

For example, when operating in the autonomous mode, the processor(s) 101 and/or the automated driving module(s) 125 control the heading and speed of the vehicle 100. The processor(s) 101 and/or the automated driving module(s) 125 cause the vehicle 100 to accelerate (e.g., by increasing the supply of energy/fuel provided to a motor), decelerate (e.g., by applying brakes), and/or change direction (e.g., by steering the front two wheels). As used herein, “cause” or “causing” means to make, force, compel, direct, command, instruct, and/or enable an event or action to occur either in a direct or indirect manner.

As shown, the vehicle 100 includes one or more actuators 117 in at least one configuration. The actuators 117 are, for example, elements operable to move and/or control a mechanism, such as one or more of the vehicle systems 109 or components thereof responsive to electronic signals or other inputs from the processor(s) 101 and/or the automated driving module(s) 125. The one or more actuators 117 may include motors, pneumatic actuators, hydraulic pistons, relays, solenoids, piezoelectric actuators, and/or another form of actuator that generates the desired control.

As described previously, the vehicle 100 can include one or more modules, at least some of which are described herein. In at least one arrangement, the modules are implemented as non-transitory computer-readable instructions that, when executed by the processor 101, implement one or more of the various functions described herein. In various arrangements, one or more of the modules are a component of the processor(s) 101, or one or more of the modules are executed on and/or distributed among other processing systems to which the processor(s) 101 is operatively connected. Alternatively, or in addition, the one or more modules are implemented, at least partially, within hardware. For example, the one or more modules may be comprised of a combination of logic gates (e.g., metal-oxide-semiconductor field-effect transistors (MOSFETs)) arranged to achieve the described functions, an ASIC, programmable logic array (PLA), field-programmable gate array (FPGA), and/or another electronic hardware-based implementation to implement the described functions. Further, in one or more arrangements, one or more of the modules can be distributed among a plurality of the modules described herein. In one or more arrangements, two or more of the modules described herein can be combined into a single module.

Furthermore, the vehicle 100 may include one or more automated driving modules 125. The automated driving module(s) 125, in at least one approach, receive data from the sensor system 102 and/or other systems associated with the vehicle 100. In one or more arrangements, the automated driving module(s) 125 use such data to perceive a surrounding environment of the vehicle. The automated driving module(s) 125 determine a position of the vehicle 100 in the surrounding environment and map aspects of the surrounding environment. For example, the automated driving module(s) 125 determines the location of obstacles or other environmental features including traffic signs, trees, shrubs, neighboring vehicles, pedestrians, etc.

The automated driving module(s) 125 can be configured to determine travel path(s), current autonomous driving maneuvers for the vehicle 100, future autonomous driving maneuvers and/or modifications to current autonomous driving maneuvers based on data acquired by the sensor system 102 and/or another source. In general, the automated driving module(s) 125 functions to, for example, implement different levels of automation, including advanced driving assistance (ADAS) functions, semi-autonomous functions, and fully autonomous functions, as previously described.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
identify, from data captured by a sensor of a vehicle, a direction specified in a user request;
map the direction specified in the user request to a corresponding location along an illumination strip encompassing a portion of the vehicle; and
activate an illumination element of the illumination strip, the illumination element is at the corresponding location along the illumination strip that maps to the direction specified in the user request.

2. The system of claim 1, wherein the machine-readable instruction that causes the processor to identify the direction specified in the user request comprises a machine-readable instruction that causes the processor to identify the direction specified in a query from a user.

3. The system of claim 1, wherein the machine-readable instruction that causes the processor to identify the direction specified in the user request comprises a machine-readable instruction that, when executed by the processor, causes the processor to identify a direction from audio captured by a microphone of the vehicle.

4. The system of claim 1, wherein the machine-readable instruction that causes the processor to identify the direction specified in the user request comprises a machine-readable instruction that, when executed by the processor, causes the processor to identify a direction from a gesture captured by the sensor of the vehicle.

5. The system of claim 4, wherein the machine-readable instruction that causes the processor to map the direction specified in the user request to the corresponding location along the illumination strip comprises machine-readable instructions that, when executed by the processor, cause the processor to:
map an angle of the gesture relative to a reference axis; and
identify, based on a lookup table, illumination elements to be activated based on a mapping between the angle of the gesture and illumination element addresses.

6. The system of claim 5, wherein the machine-readable instructions further comprise machine-readable instructions that, when executed by the processor, cause the processor to:
identify a source location of a source of the user request; and
select the lookup table from a set of lookup tables based on the source location.

7. The system of claim 6, wherein the machine-readable instruction that causes the processor to identify the source location comprises a machine-readable instruction that causes the processor to identify the source outside of the vehicle.

8. The system of claim 6, wherein the machine-readable instruction that causes the processor to identify the source location comprises a machine-readable instruction that causes the processor to identify the source inside the vehicle.

9. The system of claim 1, wherein the machine-readable instructions further comprise a machine-readable instruction that, when executed by the processor, causes the processor to identify an activation gesture that triggers identification of the direction specified in the user request.

10. The system of claim 1, wherein the machine-readable instruction that causes the processor to activate the illumination element of the illumination strip comprises a machine-readable instruction that, when executed by the processor, causes the processor to activate the illumination element to emanate light based on at least one of:
a proximity of the direction specified in the user request to the vehicle;
environmental conditions surrounding the vehicle;
a user preference; or
a seating location of a source of the user request.

11. A system, comprising:
an illumination strip attached to and encompassing a portion of a vehicle;
a processor; and
a memory storing machine-readable instructions that, when executed by the processor, cause the processor to:
identify, from data captured by a sensor of the vehicle, a direction specified in a user request;
map the direction specified in the user request to a corresponding location along the illumination strip; and
activate an illumination element of the illumination strip, the illumination element is at the corresponding location along the illumination strip that maps to the direction specified in the user request.

12. The system of claim 11, wherein the machine-readable instruction that causes the processor to identify the direction specified in the user request comprises a machine-readable instruction that causes the processor to identify the direction specified in a query from a user.

13. The system of claim 11:
further comprising a microphone disposed within the vehicle; and
wherein the machine-readable instruction that causes the processor to identify the direction specified in the user request comprises a machine-readable instruction that, when executed by the processor, causes the processor to identify a direction from audio captured by the microphone.

14. The system of claim 11:
further comprising the sensor disposed within the vehicle; and
wherein the machine-readable instruction that causes the processor to identify the direction specified in the user request comprises a machine-readable instruction that, when executed by the processor, causes the processor to identify a direction from a gesture captured by the sensor.

15. The system of claim 11, wherein the machine-readable instruction that causes the processor to map the direction specified in the user request to the corresponding location along the illumination strip comprises machine-readable instructions that, when executed by the processor, cause the processor to:
identify a source location of a source of the user request;
select a lookup table from a set of lookup tables based on the source location;
map an angle of the direction relative to a reference axis; and
identify, based on the lookup table, illumination elements to be activated based on a mapping between the angle and illumination element addresses.

16. The system of claim 11, wherein the illumination strip is on an inside of the vehicle and encompasses at least 180 degrees of:
a front portion of a cabin of the vehicle; or
a rear portion of the cabin of the vehicle.

17. The system of claim 11, wherein the illumination strip is on an outside of the vehicle and encompasses at least 180 degrees of the outside of the vehicle.

18. A method, comprising:
identifying, from data captured by a sensor of a vehicle, a direction specified in a user request;
mapping the direction specified in the user request to a corresponding location along an illumination strip encompassing a portion of the vehicle; and
activating an illumination element of the illumination strip, the illumination element is at the corresponding location along the illumination strip that maps to the direction specified in the user request.

19. The method of claim 18, wherein identifying the direction specified in the user request comprises at least one of:
identifying a direction from audio captured by a microphone of the vehicle; or
identifying the direction from a gesture captured by the sensor of the vehicle.

20. The method of claim 18, wherein mapping the direction specified in the user request to the corresponding location along the illumination strip comprises:
identifying a source location of a source of the user request;
selecting a lookup table from a set of lookup tables based on the source location;
mapping an angle of the direction relative to a reference axis; and
identifying, based on the lookup table, illumination elements to be activated based on a mapping between the angle and illumination element addresses.
